(19) United States
(12) Patent Application Publication
(10) Pub. No.: US 2008/0013461 A1
(43) Pub. Date: Jan. 17, 2008

(54) Routing key interpreter

(75) Inventors: Pierre Garnero, Sophia-Antipolis (FR); Jerome Forissier, Sophia-Antipolis (FR); Christophe Baibourdian, Sophia-Antipolis (FR); Yves Schneiner, Sophia-Antipolis (FR)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 11/483,540

(22) Filed: Jul. 11, 2006

(51) Int. Cl. G06F 12/00; H04J 1/16; G06F 9/26; H04L 12/56

(52) U.S. Cl. 370/252; 370/389; 711/216

(57) ABSTRACT

A method of providing a routing key interpreter for a signalling gateway, the method comprising the steps of generating an input file comprising a plurality of input impressions and a plurality of routing keys corresponding to the input expressions, wherein the input expressions comprise signalling message parameters, supplying the input file to a lexical analyser generator to generate a lexical analyser, and providing the routing key interpreter using the lexical analyser, wherein the step of generating an input file comprises specifying a numerical range for a signalling message parameter, generating a logical expression corresponding to the numerical range, and including the logical range corresponding to the numerical range in the input file.

### DESCRIPTION OF INVENTION

This invention relates to a method of providing a routing key interpreter and a signalling gateway comprising a routing key interpreter.

### BACKGROUND OF INVENTION

A common problem when connecting networks is that of ensuring messages from one network are correctly routed to a destination on the other network. A particular example of this is in the connection of networks using Internet Protocol (IP) to the existing telephone switched circuit network (PSTN). The infrastructure uses very different technologies and protocol: for example a PSTN uses the SS7 protocol, and it is desirable to provide PSTN signalling over an IP network reliably.

An approach to providing a reliable connection between IP and SS7 networks has been proposed by the Internet Engineering Task Force (IETF). This includes M3UA, which is a protocol for the transport of any MTP3-user signalling over IP and SUA which defines the protocol for the transport of any SCCP user signalling over IP. Two main entities are defined: the signalling gateway (“SG”), which is the connection point between the SS7 and IP networks, and the application server (AS) which is the software application provided on the IP network which it is desired to make available over the SS7 network. The protocols may be used to connect SS7-based signalling end points (SEP) with an IP based AS thus allowing SS7 networks to access IP based applications.

A function performed by the signalling gateway is to receive SS7 signalling messages and direct them to the appropriate AS. To do so, the SG identifies a routing key (RK) defined by the M3UA or SUA protocol, which uniquely identifies the AS in accordance with parameters in the SS7 message. In general, the RK parameters are found in the header of the SS7 message. However, it may be desirable to take into account other elements of the message, such as a SMS originating number or even some aspect of the message content, in order to direct the message to the appropriate AS.

Conventionally, the parameters of the SS7 message are compared with those of registered or configured RKs until an RK is found that matches them. The RK provisioning generally comprises a database which contains all of the valid routing keys and the matching message parameters. To match a received message with a routing key, the interpreter has to go through the RK database and find one which matches the parameters of the incoming SS7 message. This is potentially very complex if higher protocol layers or an unusual set of parameters have to be taken into account, and as such the interpreter must be able to deal with any allowed set of routing keys because the routing key provision is not known in advance. The interpreter cannot therefore be optimized for any given set of provisioned RKs, leading to unacceptable issues such as delays when identifying the relevant routing key. This is particularly the case where the message comprises “wild card” parameters which can take any value and so the interpreter must search through a number of combinations of possible routing keys.

As discussed in our co-pending application number EP-A-1503553, it is known to provide a routing key interpreter for a signalling gateway by supplying a plurality of input expressions which comprise parameter values of a message and a corresponding routing key to a lexical analyser generator and providing the routing key interpreter using the lexical analyser. However, as discussed this invention only allows the comparison of straightforward parameters with a regular expression. The invention is simple and very efficient, in that it is possible for example to check whether a logical expression contains a particular string of characters and identify the matching routing key.

### SUMMARY OF THE INVENTION

According to a first aspect of the invention, we provide a method of providing a routing key interpreter for a signalling gateway, the method comprising the steps of generating an input file comprising a plurality of input expressions and a plurality of routing keys corresponding to the input expressions, wherein the input expressions may comprise signalling message parameters, supplying the input file to a lexical analyser generator to generate a lexical analyser, and may provide the routing key interpreter using the lexical analyser, the step of generating an input file comprises specifying a numerical range for a signalling message parameter, generating a logical expression corresponding to the numerical range, and including the logical range corresponding to the numerical range in the input file.

The input expressions may comprise parameters of signalling messages in accordance with a first signalling protocol and the routing keys may correspond to addresses in a second signalling protocol.

The method of generating a logical expression may comprise the step of receiving a maximum value and a minimum value identifying the numerical range, and generating a logical expression readable by a lexical analyser generator.

The lexical analyser generator may generate an output comprising a source code file and the method may comprise the step of compiling the source code file to provide the lexical analyser.

The method may comprise passing the lexical analyser to the signalling gateway.

The method may comprise providing a parser operable to call the lexical analyser.

According to a second aspect of the invention we provide a routing key interpreter where generated by a method according to the first aspect of the invention.

According to a third aspect of the invention we provide a signalling gateway comprising a routing key interpreter, wherein the routing key interpreter comprises a lexical analyser, the signalling gateway being operable to receive a message from a first network, pass the message to the routing key interpreter, receive a routing key from the routing key interpreter identifying a destination address on a second network in accordance with the message, and forward the message to the destination address.

The message may be transmitted on the first network in accordance with a first protocol and on the second network in accordance with a second protocol.

### BRIEF DESCRIPTION OF DRAWINGS

An embodiment of the invention will now be described by way of example only with reference to the accompanying drawings wherein:

FIG. 1 is a diagrammatic illustration of a network including a signalling gateway embodying the present invention,

FIG. 2 is a diagrammatic illustration of the architecture of the network of FIG. 1,

FIG. 3 is a diagrammatic illustration of a signalling message,

FIG. 4 is a flow diagram showing a method of providing a lexical analyser, and

FIG. 5 shows a method of operation of a signalling gateway embodying the present invention.

### DESCRIPTION OF THE PREFERRED EMBODIMENT

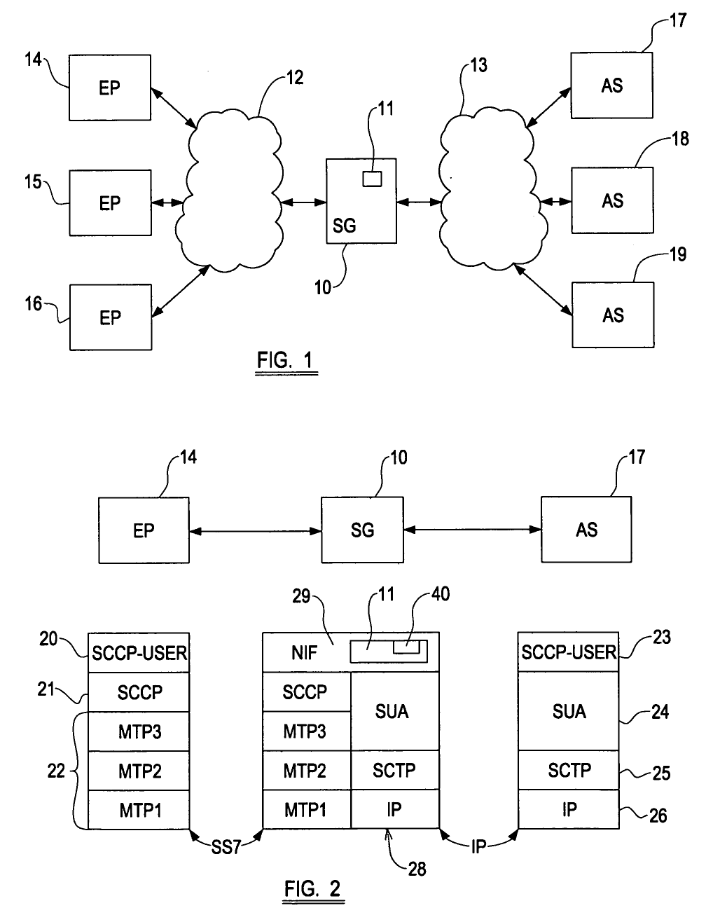

Referring to FIG. 1, a signalling gateway embodying the present invention is shown at 10, provided with a routing key interpreter 11. The signalling gateway 10 is operable to communicate over a first network 12 and send and receive messages to and from end points on the network 12 using a first protocol, in this example using the SS7 protocol. The signalling gateway 10 is also able to communicate over a second network 13, in this example using the IP protocol. The signalling gateway 10 is operable to send and receive messages via the first network 12 from a plurality of end points 14, 15, 16, and to transmit and receive messages over the second network 13 from a plurality of application servers 17, 18, 19. As best seen in FIG. 2, the protocols used for transmitting messages over the first network 12 comprise a signalling connection control part (SCCP) user part 20 over the SCCP 21 and then the appropriate message transfer (MTP) levels shown at 22. The application servers 17, 18, 19 transmit messages using an SCCP user part shown at 23 over a SCCP user adaptation layer (SUA) 24, and use the Stream Control Transmission Protocol (SCTP) over the Internet Protocol (IP) layer 26. The signalling gateway architecture generally shown at 28 has a nodal interworking function (NIF) illustrated at 29 to convert SCCP signals to SUA signals and vice versa using the routing key interpreter generally indicated at 11. The signalling gateway 10 may sit between any appropriate pair of protocols as desired, for example the signalling gateway 10 may be operable convert MTP3 signals to M3UA messages or otherwise as desired.

Each application server 17, 18, 19 has a unique routing key associated with it. The routing keys maybe configured statically at the application server 17, 18, 19 and at the signalling gateway 10, or maybe configured statically at the application server 17, 18, 19 which then dynamically registers itself at the signalling gateway by means of routing key management messages. To match a routing key to an incoming message, the routing key interpreter 11 is operable to read a message as generally illustrated at 30 and identifying the values of certain parameters within the message generally illustrated at 31, 32 and 33. The routing key interpreter 11 then identifies the routing key that matches the values of parameters 31, 32, 33 as shown in FIG. 3 and returns the appropriate routing key.

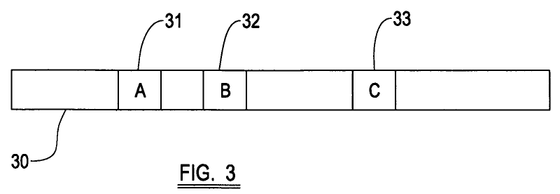

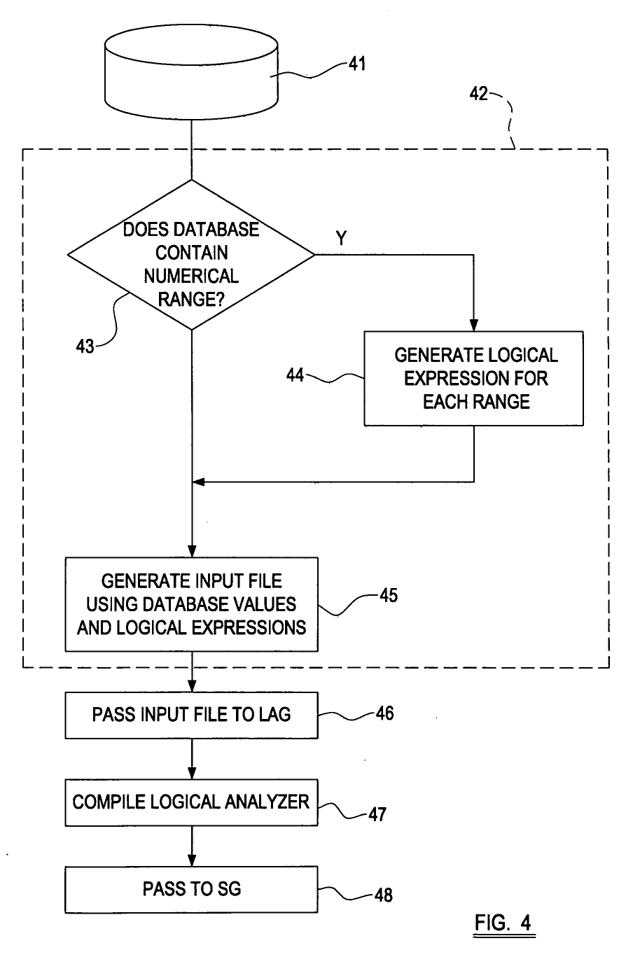

To perform the step of identifying the correct routing key, the routing key interpreter 11 comprises a lexical analyser 40. A lexical analyser is a piece of code that takes a text file as an input, searches for regular expressions within the input file and generates an appropriate output in accordance with the identified regular expressions. In the present example, the lexical analyser 40 searches for regular expressions within a received message which correspond to the values of the relevant parameters 31, 32, 33. To generate a lexical analyser, a method is performed as shown in FIG. 4. A database 41 is provided comprising a plurality of input expressions and a plurality of routing keys corresponding to the input expressions, and may be derived from, for example, the RKs registered at the signalling gateway 10. The input expressions are regular expressions which correspond to the values for the parameters 31, 32, 33 in the example of FIG. 3. At step 42, an input file is generated from the routing key and parameter information in the database 41.

As illustrated in FIG. 4, the step 42 comprises the steps of both generating a logical expression corresponding to a numerical range and also generating the input file from the input expressions corresponding to specific values for parameters 31, 32, 33 as discussed above. Consequently, in this example step 43 of the method checks whether the values for any of the parameters comprise a numerical range. If yes, then at step 44 a regular expression corresponding to the particular numerical range is generated, and at step 45 an input file is generated using the routing key and parameter information from the database 41, including the logical expression corresponding to each parameter 31, 32, 33 which has a value within a defined numerical range.

One method of generating a regular expression is set out the pseudo-code listed below.

```
-- RangeToRegexp is the entry point of the algorithm. It takes two integer
-- values and returns a regular expression string.
function RangeToRegexp(min, max: integer) returns string
  paddedMin, paddedMax: string
begin
  paddedMin = (min, left-padded to N digits with zeroes)
  paddedMax = (max, left-padded to N digits with zeroes)
-- function RangeToRegexp2 defined below
return RangeToRegexp2 ( paddedMin, paddedMax )
end RangeToRegexp
function RangeToRegexp2 (sMin, sMax: string) returns string
  len: integer
  M, m: character
  regex, rMin, rMax, rep: string
begin
len = length(min) -- number of characters in string ‘min’
for i = 0 to len loop
  m = sMin[i] // i-th digit os string ‘sMin’
M = sMax[i]
-- (m−M) is the numerical difference between digits m and M
if (m−M == 0)
  -- append digit ‘m’ to string ‘regex’
  regex = regex . m
  continue loop
endif
-- function RegexMin and re_maz defined below
rMin = RegexMin(sMin[i+1 .. len])
rMax = RegexMax(sMax[i+1 .. len])
case (m − M) in
1:
  rMin = RegexMin(sMin[i+1 .. len])
  rMax = RegexMax(sMax[i+1 .. len])
  regex = regex. “(” . m . rMin . “|” .
  M . rMax . “)”
  return regex
2:
  if (len − i − 1 == 1)
    rep = “[0–9]”
  else
  if (len−i−1 > 1)
    rep = “[0–9]{” . len−i−1 . “}”
  endif
  regex = regex . “(” . m . rMin . “|” . m+1 .
  rep . “|” . M. rMax
  return regex
[others]:
  if (len−i−1 == 1)
    rep = “[0–9]”
  else
  if (len−i−1 > 1)
    rep = “[0–9]{” . len−i−1 . “}”
  endif
  regex = regex . “(” . m . rMin . “|[” . m+1 . “−” . M−1 . “]” . rep .
  “|” . M . rMax
  return regex
  end case
end loop
end RangeToRegexp2
-- The following function generates a regex to match range mm .. 9*
-- (the number of nines is the number of digits in min)
-- E.g., RegexMin(“123”) -> regex to match “123” .. “999”
function RegexMin(min: string) returns string
  sMax: string
  regex: string
  n: integer
begin
  n = length(min)
  sMax = (string of n ‘9’ characters)
  if (min < 10)
    if (min == 9)
      regex = “9”
    else
      regex = “[” . min . “−9]”
    end if
    return regex
  end if
  return RangeToRegexp2(min, sMax)
end RegexMin
-- The following function generate a regex to match range 0* .. max
-- (the number of zeroes is the number of digits in max)
-- E.g., RegexMax(“123”) -> regex to match “000” .. “123”
function RegexMax(max: string) returns string
  sMin: string
  regex: string
begin
  n = length(min)
  sMin = (string of n ‘0’ characters)
  if (max < 10)
    if (max == 0)
      regex = “0”
    else
      regex = “[0−” . max . “]”
    end if
  return regex
  end if
  return RangeToRegexp2(sMin, max)
end RegexMax
-- End
```

Essentially, this method receives the minimum and maximum values for the numerical range, the minimum and maximum values being left padded with zeroes so that the minimum and maximum values are each N digits long. The function RangeToRegex2 begins by comparing the digits of the maximum and minimum values (m and M respectively), beginning with the left-most digit. If the digits match, then the nth digit is simply added to the logical expression.

Where the digits do not match, the RangeToRegex2 function compares the value of the digits. Where the values differ by one, the function then adds the expression (m.rMin|M.rMax.). If the values of the digits M, m differ by two, the function adds to the expression (m.rMin|m+1.rep.{N−n−1}|M.rMax) to the logical expression, where the rep is the expression [0-9] meaning any digit in the range 0-9 followed by {N-n-1}, a regular expression syntax which instructs the lexical analyser to look for that number of repetitions of the preceding character. If M and m differ by more than two, then the function adds the expression (m.rMin|[m+1−M−1] rep.{N−n−1}|M.rMax).

To provide the rMin and rMax value, the appropriate function is called. A string min comprising the nth digit of the minimum value onwards is sent to function RegexMin. If the string is a single character, the function returns a value of rMin which is either the digit 9 or [min-9]. If the string min is two or more digits long, the RegexMin function generates a new minimum value, comprising the n+1th digits onwards of min and a maximum value comprising a string of the digit 9 repeated the same number of times, and sends this value to the RangeToRegex2 function which proceeds as discussed above.

Similarly, the RegexMax function receives a string max comprising the nth digits onwards of the maximum value and checks if this is a single digit. If the single digit is zero then the RegexMax function returns the value to zero otherwise it returns the value [0-max]. If the value of max has more than two digits, then the function RegexMax calls the function RangeToRegex2 with a maximum comprising the n+1 to Nth characters of the maximum value as received, and the minimum value comprising a string of the digits 0 of the same length.

It will be apparent therefore that the functions RangeToRegex 2, RegexMin and RegexMax call each other recursively until RegexMin and RegexMax both receive a single digit string. The values for the regular expression are returned at each recursion of the RangeToRegex2 function are successively inserted in the logical expression until the recursion is complete and the logical expression is complete.

Two example ranges and their corresponding regular expressions are shown below.

### Range 0-100 Regular expression 00(0(0[0-9]|[1-8][0-9]|9[0-9])Å100)

### Range 1280-5197 Regular expression 0(1(2(8[0-9]|9[0-9])|[3-8][0-9]{2}|9(0[0-9]|[1-8][0-9]|9[0-9]))|[2-4][0-9]{3}|5(0(0[0-9]|[1-8][0-9]|9[0-9])|1(0[0-9]|[1-8][0-9]|9[0-7])))

It will of course be apparent that any other alternative method for generating a regular expression corresponding to a numerical range [min, max] may be provided as desired.

At step 46 the input file is passed to a lexical analyser generator such as LEX or FLEX or any other lexical analyser generator as required. In general, lexical analyser generators generate a source code file as their output, so at step 47 the source code file is compiled to provide an executable file, and at step 48 the lexical analyser is passed to the signalling gateway 10. The lexical analyser may be passed to the signalling gateway 10 by, for example, providing the lexical analyser as a sharable library which is dynamically loaded by the signalling gateway 10. If desired, the routing key interpreter 11 may be provided with an appropriate parser, such as YACC or BISON, to call the lexical interpreter and handle the returned routing key or otherwise as appropriate.

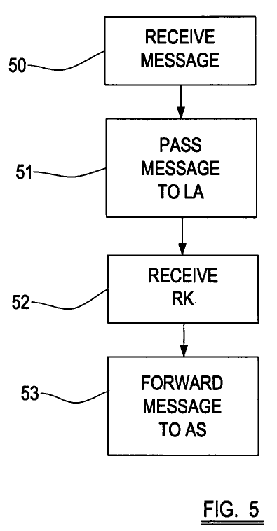

As shown in FIG. 5, at step 50 the signalling gateway 10 can receive a message and at step 51 passes the message to the routing key interpreter 11. The routing tag interpreter reads the SS7 message to obtain the parameter values 31, 32, 33 and generates a string containing the parameter values. The string is passed to the lexical analyser 40 to identify the matching routing key. The routing key interpreter 11 will then return the routing key as shown in step 52, and the signalling gateway 10 will forward the message to the appropriate application server 17, 18, 19 identified by the routing key as shown at step 53.

This method is thus particularly advantageous in that the lexical analyser 40 is always optimised for the particular set of routing keys and the associated input expressions which can be handled by the signalling gateway 10 and can accommodate parameter values which must be within a defined range. For example, it might be desirable to route all messages to a specific application server 17, 18, 19 if the CIC (circuit identification code) parameter value in a received SS7 message is within a specific range. By generating a logical expression corresponding to that numerical range and including that in the input file associated with the corresponding routing key, the routing key interpreter 11 will obtain a match for a CIC value having any value within that range and thus returning the correct routing key. It will be apparent that any other parameter having a numerical range of values, for example DPC (designation point code) or OPC (originating point code) or indeed any other parameter. Where desirable, it may even be appropriate to provide regular expressions in a similar manner for parameters where there may be a range of characters not limited to numerical digits. The input file can comprise a simple text file listing the relevant input expressions corresponding to values of the parameters 31, 32, 33 and the corresponding routing key, for example in the simple format (field=value; field=value; . . . ; result) where value can be a simple value or a logical expression corresponding to a numerical range. It thus follows that if the routing key provisioning needs to be updated, the pre-existing input file can be simply modified by adding or deleting appropriate lines of text, and a new lexical analyser generated by passing the input file to the lexical analyser generator, and then passing the lexical analyser to the signalling gateway 10.

The present invention may be used to provide a signalling gateway between any appropriate pair of networks using different protocols as desired.

In the present specification “comprises” means “includes or consists of” and “comprising” means “including or consisting of”.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A method of providing a routing key interpreter for a signalling gateway, the method comprising the steps of:
generating an input file comprising a plurality of input expressions and a plurality of routing keys corresponding to the input expressions, wherein the input expressions comprise signalling message parameters,
supplying the input file to a lexical analyser generator to generate a lexical analyser, and providing the routing key interpreter using the lexical analyser,
wherein the step of generating an input file comprises specifying a numerical range for a signalling message parameter,
generating a logical expression corresponding to the numerical range, and
including the logical range corresponding to the numerical range in the input file.

2. A method according to claim 1 wherein the input expressions comprise parameters of signalling messages in accordance with a first signalling protocol and the routing keys correspond to addresses in a second signalling protocol.

3. A method according to claim 1 wherein the method of generating a logical expression comprises the step of receiving a maximum value and a minimum value identifying the numerical range, and generating a logical expression readable by a lexical analyser generator.

4. A method according to claim 1 wherein the lexical analyser generator generates an output comprising a source code file and the method comprises the step of compiling the source code file to provide the lexical analyser.

5. A method according to claim 1 comprising passing the lexical analyser to the signalling gateway.

6. A method according to claim 1 comprising providing a parser operable to call the lexical analyser.

7. A routing key interpreter where generated by a method according to any one of the preceding claims.

8. A signalling gateway comprising a routing key interpreter, wherein the routing key interpreter comprises a lexical analyser, the signalling gateway being operable to;
receive a message from a first network,
pass the message to the routing key interpreter,
receive a routing key from the routing key interpreter identifying a destination address on a second network in accordance with the message, and
forward the message to the destination address.

9. A signalling gateway according to claim 9 wherein the message is transmitted on the first network in accordance with a first protocol and on the second network in accordance with a second protocol.
